(19) United States
(12) Patent Application Publication
(10) Pub. No.: US 2019/0392216 A1
(43) Pub. Date: Dec. 26, 2019

(54) SYSTEM AND METHOD FOR PROJECTING AUGMENTED REALITY IMAGES

(71) Applicant: Huntington Ingalls Incorporated, Newport News, VA (US)

(72) Inventor: Daniel J. McPeters, Newport News, VA (US)

(21) Appl. No.: 16/374,933

(22) Filed: Apr. 4, 2019

Related U.S. Application Data
(60) Provisional application No. 62/763,597, filed on Jun. 22, 2018.

(51) Int. Cl. G06K 9/00; G06T 19/00; G06T 7/73; G06T 7/60; G06T 7/521

(52) U.S. Cl. CPC G06K 9/00671; G06T 19/006; G06T 7/521; G06T 7/60; G06T 7/73

(57) ABSTRACT

A method is provided for projecting augmented reality information associated with a target object. The method includes providing an augmented reality projector (ARP) having a digital image projector, a visual spectrum camera (VSC), and a sensor arrangement including at least one depth sensor, all aligned along an ARP line of sight. The method further includes directing the ARP line of sight toward a target surface of the target object and capturing a visual digital image using the VSC and target surface data using the sensor arrangement. The method still further includes determining, by an automated data processor, a pose of the ARP relative to the target surface, and constructing, by the automated data processor, an augmented reality image for display on the target surface. The method still further includes projecting, by the digital image projector, the augmented reality image onto the target surface.

This application claims priority to U.S. Prov. App. No. 62/763,597, filed Jun. 22, 2018, the complete disclosure of which is incorporated herein by reference.

### BACKGROUND OF THE INVENTION

This application relates generally to augmented reality (AR) applications and, more particularly, to a handheld augmented reality projector.

Digital augmented reality is defined as the overlay of digital information on the real world by use of mobile computing, and it has been realized through a variety of devices including smart phones, tablets, and various head-mounted displays—where the augmentation exists on a digital screen or display. Analog AR is likewise considered to be overlay of information, but through the use of an active laser projection system or visible light based computer presentation projectors to project images onto physical surfaces.

Augmented reality is used in industrial applications in 2018 primarily through the use of mobile interface devices. As used herein, the term “mobile interface device” refers to any mobile computing solution that is used to facilitate communication and display information, including, but not limited to tablet computers, smartphones, and wearable heads-up displays. Typically, cameras and/or other sensor(s) (e.g., infra-red, visual-inertial, or GPS) are used by such devices to establish device pose (position of the device relative to a reference frame or physical object), and the device displays the camera feed with accurately overlaid digital information.

Mobile interface device display of AR information, however, has significant shortfalls.
Field of View: As shown in FIG. 1, a user 10 must position himself relatively far from the object being augmented to account for the limited field of view of the camera (displayed on mobile device 30). In many cases, this offset distance is so large that relevant actions (e.g. marking a physical surface, taking a measurement, tightening a fastener) requiring the augmented display cannot be accomplished by the person using the mobile interface device. Instead, the user must rely on or direct a second person 20 to take action in the physical world. This second person is often in a position where they can't see the augmentation. This effectively doubles the cost of AR usage to solve industrial problems.
Lack of Hands-Free Use: Tablet based AR must be pointed at the object of interest for the AR to function since the camera is used to fill the display. While there are some opportunities to use tripods or other “third arm” approaches, in general, the user must also be behind the display to see the augmentation for it to be of use. Thus it is typical that the AR user is required to hold the tablet to benefit from the augmentation. It is not possible to do many industrial tasks without both hands available. Thus, a user must choose between having the AR data available and having his hands available.
Conflict of Visual Focus—As shown in FIG. 2, a mobile device 30 captures live video of physical objects 41, 42 and digital versions 41′ and 42′ are displayed on the device display screen 32. The mobile device 30 uses computer vision (CV) software to calculate the placement of digital AR content 50 appropriate for the physical objects 41 and 42. This can create a disorienting effect to the user when switching focus from the physical environment line of sight 12 to the device screen line of sight 14 and back.

Optically transparent, head mounted displays (HMDs) using beam-splitting or wave-guide technology are a common solution to the “hands free” shortfall of tablets and smart phones. As shown in FIG. 3, HMD hardware or digital eye-wear 60, overlays digital content 50 onto transparent material 62 in front of the user's eyes using CV software. In some cases, they may also ameliorate the field of view problem. However these hardware solutions to Digital AR in industrial conditions carry their own shortcomings:
Safety: Wearing head-mounted displays showing AR tends to reduce the wearer's situational awareness, interfere with personal-protective equipment (PPE; e.g. hardhats, hearing protection, eye protection), and can raise many heat, weight, and other ergonomic concerns.
Persistence: In general, AR deployed HMDs are either “on” or “off”. When on, the AR is persistently there, and can become a nuisance in many scenarios. Unlike a tablet, an AR user can't easily put down or pick up his HIVID. If off, the information is unavailable, and typical boot times make it impractical for AR-enabled HMDs to be turned on and off successively, and remain effective.
Conflict of Visual Focus—Although not to the same noticeable degree as using mobile devices with screens, HMDs can create focal difficulties for the user when determining the physical location of augmented content at close proximity. For example, when transcribing with a pencil a physical mark onto a surface that corresponds with a digital augmentation of a drill point, a user will experience a focal conflict due to the augmentation being closer to the eye than the physical object accepting the drill point mark. This can create a disorienting effect to the user.

Modern laser projection systems offer an analog AR solution to many industrial problems such as part placement, inspection, lofting, etc. Laser projection systems can place light fields on physical objects dynamically (changing with time), and with a high degree of accuracy relative to digital AR. Such analog tools also have limitations.
Mobility: Laser projection systems require a relatively large degree of setup time compared to mobile digital AR systems, and tend to be heavy, have multiple parts, and require dedicated power supplies. These features tend to significantly reduce mobility, particularly when compared to typical mobile interface devices such as tablets and smart phones.
Calibration: Laser projection systems can deliver a higher relative degree of accuracy over their mobile digital AR counterparts, but this comes at a high cost of repetitive calibration. Typically, for each setup, a laser projection system must understand the environment and establish its own pose to account for keystone and surface distortion, and deliver the desired accuracy.

The low cost of standard computer projectors has resulted in their introduction into industrial build sites where users can use them to project drawings, data, instructions, or other information onto a real surface. This is yet another type of analog AR that can provide value, but also has shortcomings.
Keystone Effect: perhaps the most challenging drawback to using computer projectors is the requirement for the projector to be orthogonal to the projection surface. If the projector is not so positioned, the projected image is skewed so that its relative dimensions are no longer accurate. A rectangular image projected on a flat surface, for example, appears as a trapezoid (i.e., similar to shape of a keystone). The optical problem is accordingly referred to as the “keystone effect”. Typically, this can be accounted for with physical setup, or with controls on the projector that allow for digital or mechanical corrections to non-orthogonal alignment to the screen or surface; however, this results in an immobile system and is subject to local effects (e.g. bumps, walking, vibration).
Full Light Field: Commercially available projectors will typically fill a rectangular box of either 4:3 or 16:9 dimensional ratio with light. “White” typically is projected light, and “black” is the absence of light projected. It is common, particularly in AR field applications, for computer projection solutions to include drawings, schematics, or documents onto the physical surface. It is typical for these products to have been produced for paper printing—and thus are commonly black text or lines on white background. The result of projecting these items is excessive light being used, which creates shadows and eye strain should an AR user inadvertently look into the projector.
Mobility—Standard projectors require a relatively large degree of setup time compared to mobile digital AR systems, and tend to incorporate connection to laptops or desktop computers running software for lighting controls. These systems are created for a projector to be in a known fixed location in reference to a known projection surface. This eliminates the movement of the projector on any plane or axis.

### SUMMARY OF THE INVENTION

An illustrative aspect of the invention provides a method of dynamically projecting augmented reality information associated with a target object. The method comprises providing an augmented reality projector (ARP) comprising a digital image projector, a visual spectrum camera (VSC), and a sensor arrangement including at least one depth sensor, all aligned along an ARP line of sight. The method further comprises directing the ARP line of sight toward a target surface of the target object. A visual digital image is captured using the VSC and target surface data are captured using the sensor arrangement. The method still further comprises determining, by an automated data processor, a pose of the ARP relative to the target surface, and constructing, by the automated data processor, an augmented reality image for display on the target surface. The method still further comprises projecting, by the digital image projector, the augmented reality image onto the target surface.

Another illustrative aspect of the invention provides an augmented reality projector comprising a housing and a digital image projector at least partially disposed within the housing. The digital image projector is configured to receive digital image information and use the digital image information to project an image onto a target surface of an object along a projector line of sight. The augmented reality projector further comprises a visual spectrum camera (VSC) at least partially disposed within the housing and having a VSC line of sight substantially parallel to the projector line of sight so as to capture a visual digital image of the target surface. The augmented reality projector also comprises a sensor arrangement including at least one depth sensor oriented and aligned to capture surface information from the target surface. The augmented reality projector also comprises a data processor in communication with the digital image projector, the visual spectrum camera, and the depth sensor arrangement. The data processor is configured to receive the captured visual digital image from the VSC and the captured surface information from the sensor arrangement, to construct an augmented reality image for display on the target surface, and to transmit the augmented reality image to the digital image projector for projection onto the target surface.

Another illustrative aspect of the invention provides an augmented reality projection system comprising a sensor and projection unit and a mobile interface device. The sensor and projection unit comprises a housing and a digital image projector at least partially disposed within the housing. The digital image projector is configured to receive digital image information and use the digital image information to project an image onto a target surface of an object along a projector line of sight. The sensor and projection unit further comprises a visual spectrum camera (VSC) at least partially disposed within the housing and having a VSC line of sight substantially parallel to the projector line of sight so as to capture a visual digital image of the target surface. The sensor and projection unit comprises still further comprises a depth sensor arrangement at least partially disposed within the housing. The depth sensor arrangement is oriented and aligned to capture surface information from the target surface. An input/output arrangement is in communication with the digital image projector, the VSC and the depth sensor arrangement. The mobile interface device comprises a communication interface selectively connectable to the input/output arrangement of the sensor and projection unit and a data processor. The data processor is in selective communication with the digital image projector, the VSC, and the depth sensor arrangement when the communication interface is connected to the input/output arrangement. The data processor is configured to receive the captured visual digital image from the VSC and the captured surface information from the sensor arrangement, to construct an augmented reality image for display on the target surface, and to transmit the augmented reality image to the digital image projector for projection onto the target surface.

### BRIEF DESCRIPTION OF THE DRAWINGS

The invention can be more fully understood by reading the following detailed description together with the accompanying drawings, in which like reference indicators are used to designate like elements, and in which:

FIG. 1 illustrates a prior art method for viewing AR information;

FIG. 2 illustrates a prior art method for viewing AR information;

FIG. 3 illustrates a prior art method for viewing AR information;

FIG. 4 depicts an illustrative use of an augmented reality projector according to an embodiment of the invention;

FIG. 5 is a schematic representation of an augmented reality projector according to an embodiment of the invention

FIGS. 6A, 6B, and 6C illustrate the use of a prior art projector;

FIGS. 7A, 7B, and 7C depict an illustrative use of an augmented reality projector according to an embodiment of the invention;

FIG. 8 is a perspective view of an augmented reality projection system according to an embodiment of the invention; and

FIG. 9 is a block diagram of a method of projecting an AR image according to an embodiment of the invention.

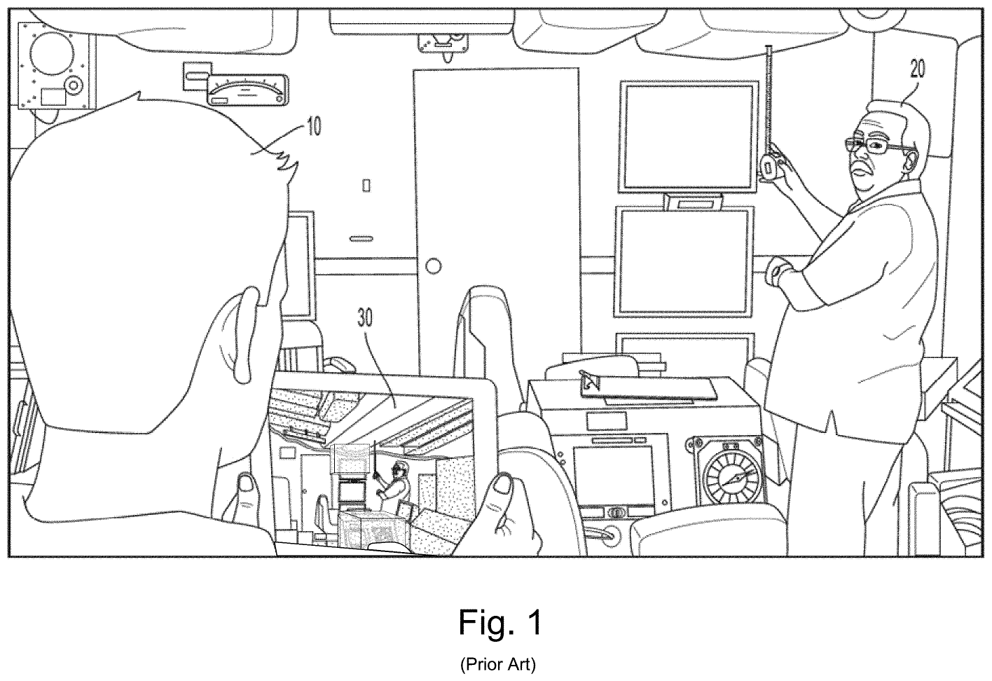

### DETAILED DESCRIPTION OF THE INVENTION

While the invention will be described in connection with particular embodiments, it will be understood that the invention is not limited to these embodiments. On the contrary, it is contemplated that various alternatives, modifications and equivalents are included within the spirit and scope of the invention as described.

The present invention combines analog and digital AR elements to provide an advancement in digital AR hardware and overcome the shortfalls of existing display solutions. A particular aspect of the invention provides an augmented reality projector (ARP) that overcomes the field of view, hands-free, safety, persistence, mobility, calibration, and keystone shortfalls of other AR systems, and through dedicated and unique use, can also overcome the full light field shortfall.

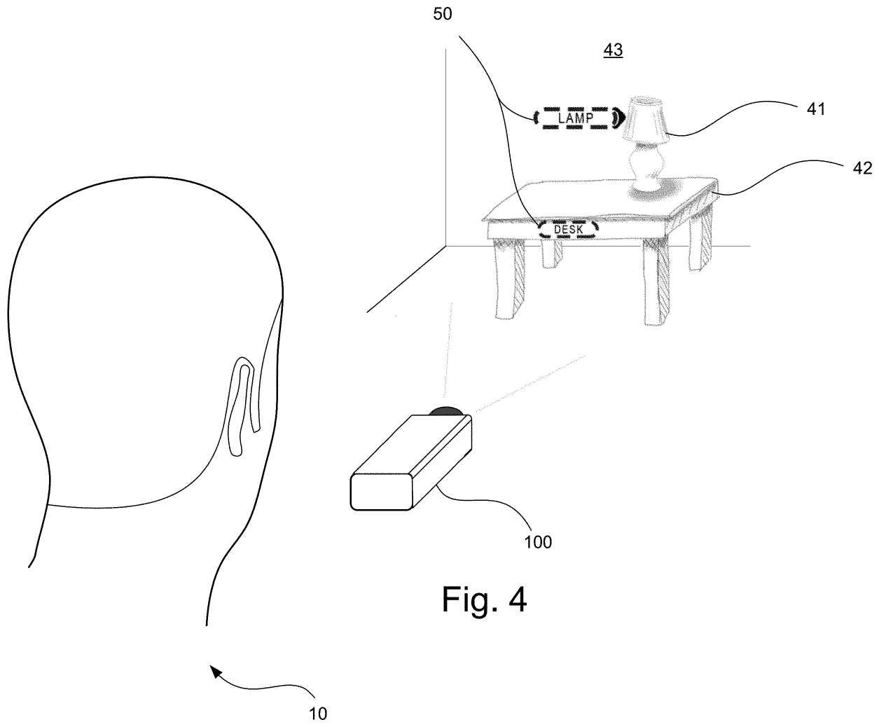

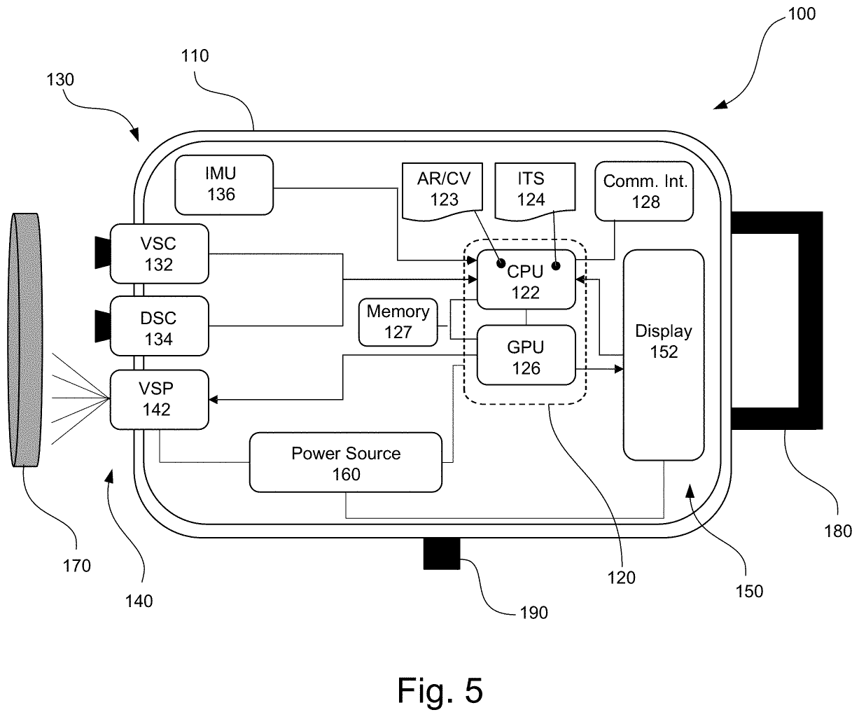

An ARP of the present invention overlays digital content in a new way for mobile platforms. It does not require the user to look at a video overlay on a screen nor wear hardware that requires see-through projections. Instead, as shown in FIG. 4, an ARP 100 according to an embodiment of the invention projects digital content 50 directly onto surfaces in the physical environment. In the example of FIG. 4, the word “DESK” is projected onto a surface of the desk 42 and the word “LAMP” is projected on the wall 43 so that, from the perspective of the observer 10, it appears adjacent the lamp 41.

An exemplary ARP according to an embodiment of the invention may be a hand-held or mountable smart projector that when shined on an object, depicts digital information about that object as pre-programmed using onboard software. Augmented reality/computer vision (AR/CV) and depth sensing technology enable the augmentation to “lock onto” the object, so that as images projected by the ARP are moved across the surface, the physical augmentations are locked in place—effectively acting like a flashlight to “reveal” digital information on the physical surface of an object within the projector's light field.

Unlike a physical tablet AR solution, the augmentation appears to be present on the physical object through light from the visual spectrum projector. Thus, the ARP unit can be set down and the AR user will still see the augmentation on the object—without any need to view a device display screen. This eliminates the need for two people to conduct spatially driven AR tasks. Since the AR user can set the unit down and walk up to the physical object with hands free, the constraints of tablet driven AR may be eliminated.

In various embodiments, the ARP can be “turned off” by a blackout button or a physical lens cover to eliminate the persistence shortcoming, and there is no interference with an AR user's PPE. In fact, a supplemental light source is a common piece of PPE that the ARP of the invention can replace.

The ARPs of the invention may have a high degree of mobility and easier/simpler calibration requirements than analog laser systems while still providing the “on object” augmentation that laser projection systems are valued for. ARP calibration may be driven by the selected AR/CV solution, and typically a fiducial marker will set scale and origin for the computations, though object recognition or other calibration approaches are also possible, consistent with the selected AR/CV technology.

Finally, the ARPs of the invention may incorporate digital features and additional sensors to address the Keystone effect and full light field issues. Although some projectors include an automatic keystone correction feature, they tend to distort the scale of the projection. The digital keystone correction used in the ARPs of the invention counter the problem without distortion, assuring accurate scale of the augmentation. Regarding full light field effects, it will be understood that poorly designed augmentation views can present full light field issues. AR solutions, however, do not generally fill very much of the screen. Moreover, careful design practices such as using a black background to replace the visual spectrum camera feed shown on the display, can be used to ensure minimal light projection.

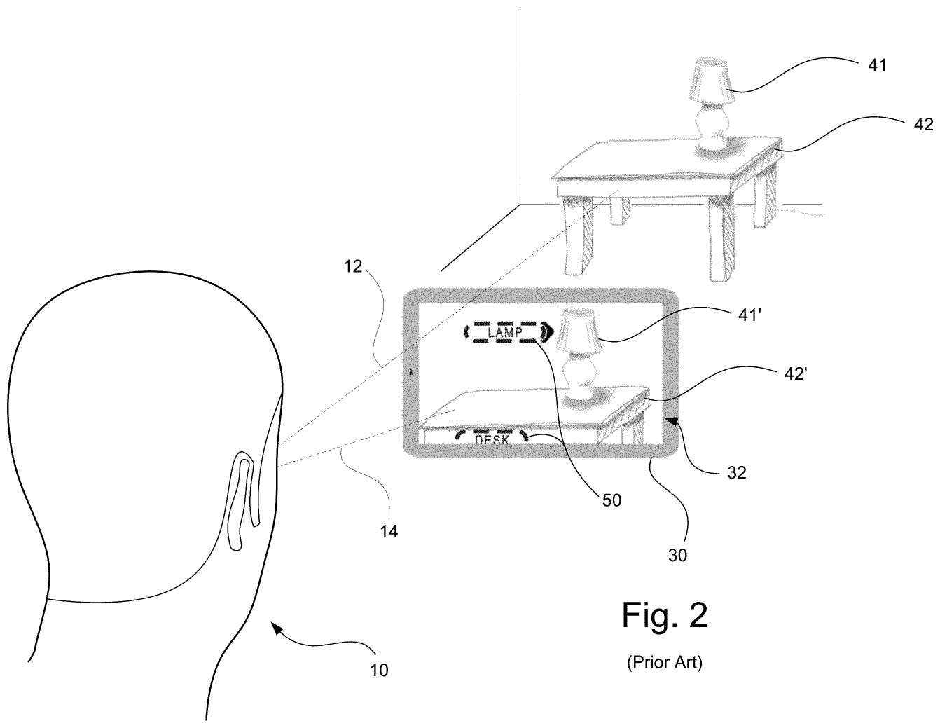

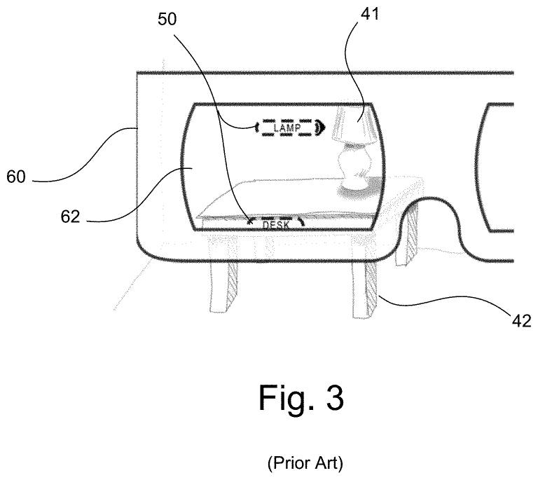

An exemplary embodiment of the invention will now be discussed in more detail. With reference to the schematic representation of FIG. 2, an augmented reality projector 100 comprises a housing 110 in which may be disposed a data processor 120, a sensor arrangement 130, a projection arrangement 140, user interface 150, and a power source 160. In some embodiments, the data processor 120 and/or the user interface 130, or portions of either may be external to the housing 110.

The data processor 120 comprises central processing unit (CPU) and a display processor or graphics processing unit (GPU) 126. The user interface 150 is in communication with the data processor 120 and may include a physical visual display 152. The visual display 152 may make the AR initialization and operation easier (although other human-computer interfaces (voice) and the projected AR display may be sufficient). In some embodiments of the invention, the data processor 120 and user interface 150 may be provided by a mobile interface device (e.g., a commercial tablet computer) connected to or connectable to the housing 110 and/or components disposed within the housing 110. The operating system of the tablet or other data processor 120 may be variable/non-specific, as may be the software programming language used. The user interface 150 may be configured for touch, voice, gesture, or other input methods and allows a user to launch applications and or use other controls. A visual display 152 of the user interface 150 (e.g., the display screen of a tablet) can optionally be used to display visual camera views and/or AR content. In some embodiments, the user interface 150 may include a head mounted display (HMD).

The sensor arrangement 130 of the exemplary ARP 100 includes a visual spectrum camera (VSC) 132, a depth sensing camera (DSC) 134, and an inertial measurement unit (IMU) 136. In embodiments where the ARP 100 incorporates a tablet or other mobile interface device, some or all of these sensors may be native to that device. In other embodiments, individual units such as an IR sensor for the DSC 134, visual camera for the VSC 132, and an accelerometer-based IMU 136 may be disposed within or attached to the housing 110. The output of these sensors is received by the CPU 122, which comprises isometric transformation software (ITS) 124 and AR/CV software 123 to perform the calculations necessary to determine the pose of the ARP 100 and to generate the appropriate AR output. Many commercial options are available for AR/CV software 123 including, without limitation, HoloKit, ARKit, ARCore, Vuforia, and others. In embodiments where a mobile interface device is used, but the sensors are separate from the mobile interface device, the AR/CV software 123 may comprise software such as PrimeSense, MS Kinect or the like. The specific approach to sensor/software combinations may be driven by such factors as cost, range, accuracy, and battery endurance.

The AR/CV software 123 may use previously determined information related to a target object to generate the AR image. Such information may be retrieved by the CPU 122 from an on-board memory 127. In some embodiments, however, the CPU 122 may retrieve the information from an external server via a wireless or wired communication interface 128. In some embodiments, the AR image content may be provided by a user via the user interface 150.

The DSC 134 provides information necessary to determine the pose of the surface on which AR information is to be displayed. This differs from the situation where the information is merely displayed on a tablet screen or an HIVID. In a typical tablet-type display solution, this is not necessary. Projecting AR onto surfaces in the physical world, however, requires that the isometric orientation of the projector relative to the surface be more accurately understood and taken into account for the projection. The ITS software 124 is configured to transform the AR/CV pose-calculated augmentation so that it accounts for the physical keystone effect. It may also account for variations in the physical surface (i.e., the surface topography). Such transformations can only be done accomplished with accurate information on the range and orientation of the ARP 100 relative to the projection surface.

In some applications, the projection surface distance and orientation may be known in advance and included in the AR/CV geometric model environment. In such cases, calculations may be made based on that digital representation, but this method may be less reliable for most industrial applications.

In some embodiments, the output of the DSC 134 and/or the VSC 132 could also be used for AR tracking.

The projection arrangement 140 includes an optical (visual spectrum) projector (VSP) 142 for projection of digital AR imagery, which may be corrected for keystone effects and surface topography. Any suitable commercial VSP unit may be used. The VSP may be connected to an on-board power supply (e.g., a battery pack). Alternatively, the VSP and/or other ARP components may be powered by an external power source. The VSP is fixed relative to the sensor arrangement 130 to assure that the proper projection pose is maintained.

The ARP 100 may also include a handle arrangement 180 and one or more lens caps 170 to cover one or more of the projector lens, a DSC lens, and a VSC lens. A tripod receiver 190 or other mechanism may be included for attaching the housing 100 to a fixed or portable support.

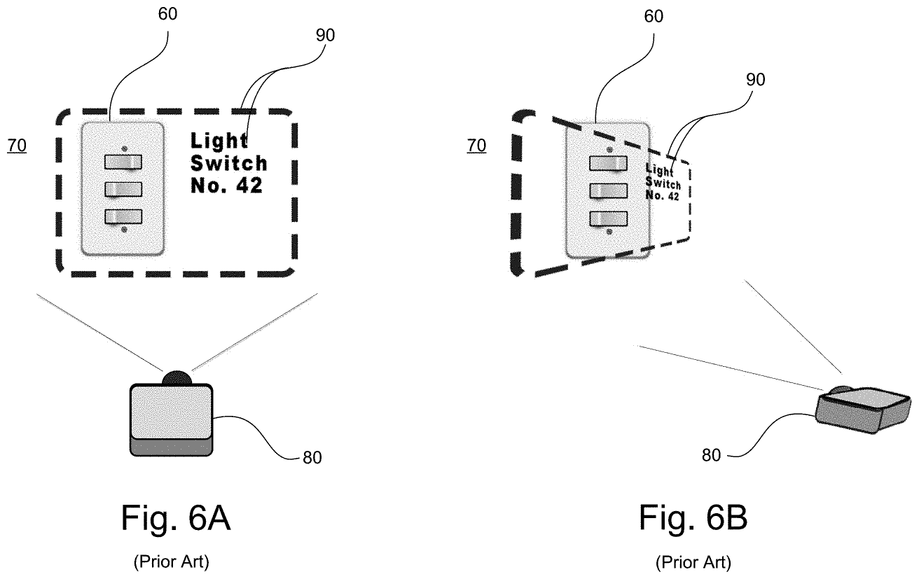

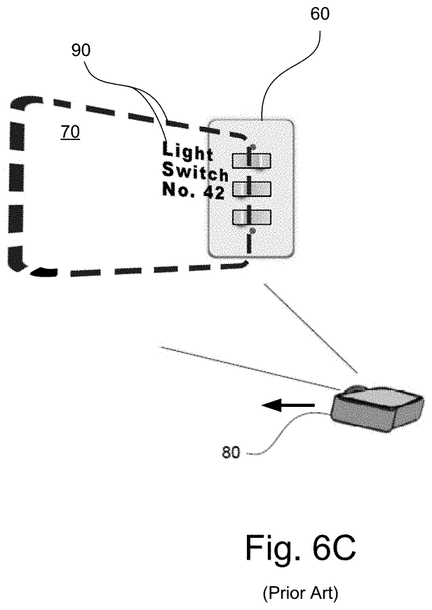

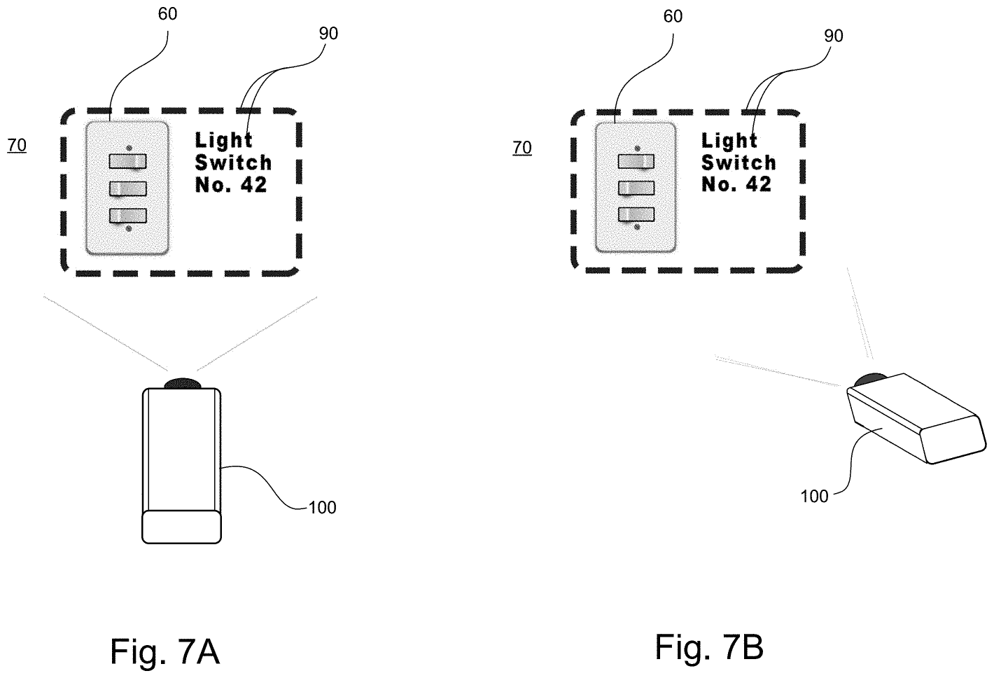

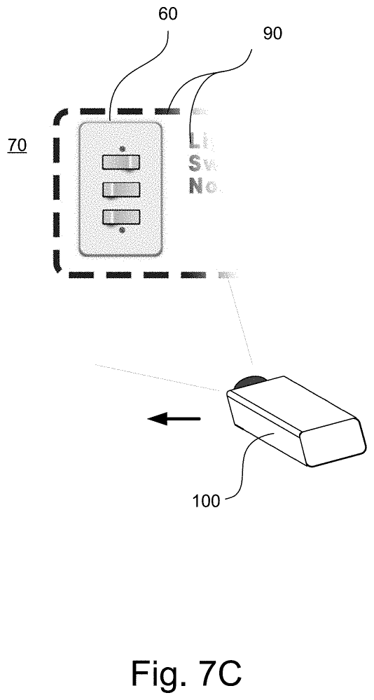

The ARP 100 is capable of mobility because it uses data from the DSC 134, VSC 132 and IMU 136 to initialize and maintain spatial awareness of the physical environment that it is in and uses CV software to calculate device pose, and constantly adjusts not only what content it should project based on its pose, but also how to project the content using its knowledge of the current projection surface. This is in direct contrast to a standard projector. FIG. 6A illustrates a physical light switch 60 on a wall surface 70. A standard projector 80 is used to display digital content 90 on the wall 70 adjacent the light switch. When the projector is aligned normal to the wall surface 70 at the proper distance, the digital content 90 is properly positioned and proportional to the physical feature (i.e., the light switch 60). This can be achieved with any standard projector arranged perpendicular to projection surface and calibrated to align as desired. If, however, the standard projector 80 is shifted to one side, the projector must be angled so that the digital content 90 angle stays in position adjacent the light switch 60, as shown in FIG. 6B. This results in the apparent foreshortening of the digital content projection 90 so that it is skewed in relation to the physical feature object 60 (the keystone effect). Modern projectors provide keystone correction capabilities but the function is either manual or automatic at low sample rates and standard presets. As shown in FIGS. 7A and 7B, however, the sensors of the ARP 100 perceive the change in the angle of the device with respect to the wall surface 70 and automatically alters the digital content projection 90 to compensate for the change and maintain its position and appearance as perceived by a viewer.

Another way to understand how this is accomplished is by imagining that a virtual camera exists in the digital environment at the same point and orientation in space as the physical ARP in the physical environment. The physical ARP only projects the point of view of a virtual camera existent in the digital environment, and since the physical and digital environments are linked by CV software, the foreshortened point of view of the digital content captured by the virtual camera will project as seen foreshortened, creating an equally opposing skew when physically projected. By this effect, the digital content remains true to the physical environment.

FIG. 6C shows the effect of translation of the standard projector 80 without a change in the projection angle. In this case, the digital content 90 translates in the direction of the arrow along with the projector 80, causing the mis-positioning of the digital content relative to the physical object 60. In contrast, as shown in FIG. 7C, the sensors of the ARP 100 perceive the translational changes with respect to the physical environment and the device continually updates the digital content projection 90 to maintain the position and relevance of the augmentation to the physical object 60. Thus, as the ARP 100 moves in the direction of the arrow, less and less of the digital content associated with the light switch is actually projected, From the perspective of a viewer, the effect of the moving projector is similar to that of a moving flashlight, “illuminating” digital content and then leaving it behind “in the dark”.

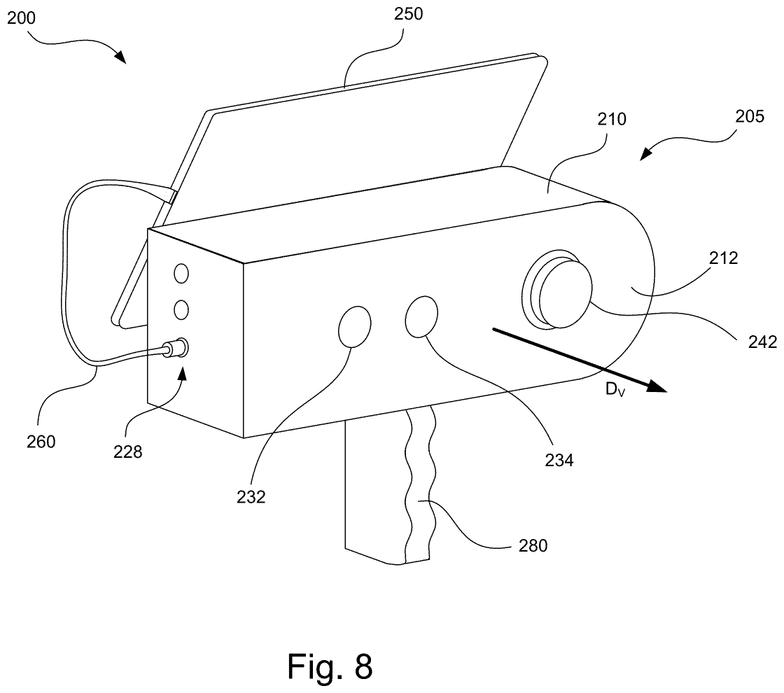

FIG. 8 illustrates an ARP system 200 according to a particular embodiment of the invention. The ARP system 200 comprises a sensor and projection unit 205 connected or connectable to a mobile interface device 250. The sensor and projection unit 205 comprises a housing 210 in which various sensor components may be disposed. In the illustrated embodiment, a VSC 232, a DSC 234 and a VSP 242 are disposed within the housing 210 and are configured and positioned to provide viewing through (or to extend through) apertures in the housing's forward wall 212. The VSC 232, DSC 234 and VSP 242 may be substantially similar to those of previous embodiments and are positioned so that they have parallel lines of sight in a viewing direction Dv. The sensor and projection unit 205 also comprises an input/output arrangement 228, which may include, for example, a port for receiving the end of a cable 260 connected to the mobile interface device 250.

In some embodiments, the sensor and projection unit 205 may include an on-board data processor connected to the VSC 232, DSC 234 and VSP 242 and/or additional sensors such as an IMU. In such embodiments, the on-board data processor may receive and process sensor data to determine the pose of the device and generate AR information for projection by the VSP 242. Processed information may also be passed to the mobile interface device 250 via the cable 260 and the communication interface of the mobile device.

In alternative embodiments, the primary processing capability of the system may be provided by a data processor of the mobile interface device 250. In these embodiments, data from the cameras and/or other sensors may be passed via the input/output arrangement 228 to the data processor of the mobile interface device 250, which may then combine this information with its own sensor data (e.g., IMU data), determine the pose of the sensor and projection unit 205 and generate the appropriate AR image information. The AR image information may then be passed via the input/output to the VSP 242 for projection.

The mobile interface device 250 may be any conventional tablet or other mobile processing device. In various embodiments, the mobile interface device 250 can be used for all user input-output functions. For ease of use, the mobile interface device 250 may be attached or attachable to the sensor unit housing 210 in such a way that it is generally aligned with the viewing direction Dv of the sensor and projection unit 205. Communications to and from the mobile interface device are passed to the device's data processor via a communications interface. A pistol-grip handle 280 may be attached to the bottom of the housing 210 to allow a user to hold the combined sensor and projection unit and mobile interface device with one hand and enter information on the mobile interface device 250 with the other.

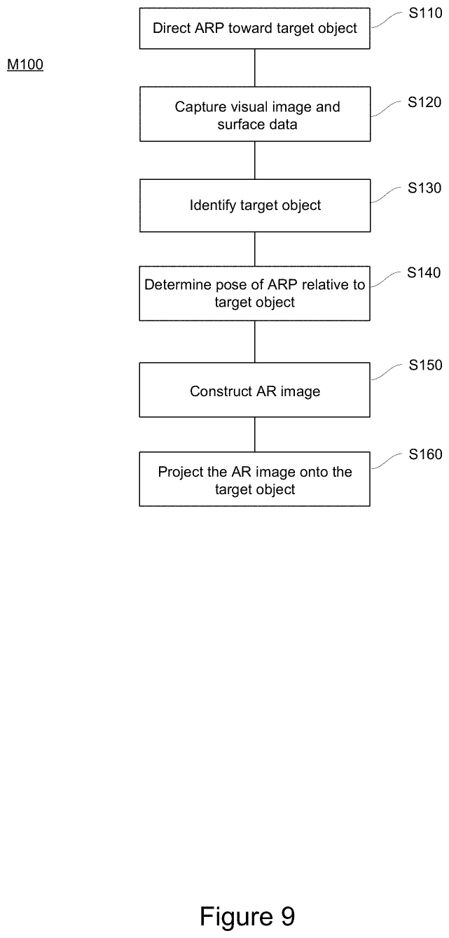

FIG. 9 is a block diagram of a method M100 of projecting environment-relevant AR images using an ARP according to an embodiment of the invention. The method M100 begins at S110 when an activated ARP is directed toward a target object or area within the environment in which the ARP is disposed. At S120, the ARP captures a digital visual image of the target object or area along the line of sight of the ARP. The ARP simultaneously captures sensory information about one or more surfaces of the portion of the target object or area captured within the visual image. The sensory information may be captured using a depth sensing camera or other sensor(s) for providing information suitable for determining the surface topography of the target object. At S130, the visual image and sensory information may optionally be used by a data processor within the ARP to identify the target object or area. This may be accomplished using object recognition software for comparison of the captured image to known objects or areas. At S140, the data processor uses the image and sensory information to determine a pose of the ARP relative to the target object or area.

At S150, the data processor constructs an AR image for display on a surface of the target object or area. In particular embodiments, the AR image is constructed using information relevant to the target object or area. This information may be set by a user or may be retrieved from data storage by the data processor based on identification of the target object or area. In certain embodiments, the data processor may request and receive object information from a remote server and/or object database. The information may include specific indicia to be displayed and the location where the indicia is to be displayed relative to the target object.

The AR image is constructed so that its appearance and position relative to the target object are the same regardless of the position and orientation of the ARP. The ARP data processor uses the surface topography of the target object or area and the pose (i.e., distance, line of sight angle, and orientation) of the ARP to determine the area of the target object that will be covered by the projected image and to determine the adjustments that must be made to the digital AR image so that when projected, the image will appear undistorted to any viewer within the environment. At S160, the AR image is projected onto the target object or area. The actions of the method may be repeated continuously in real time so that the pose of the ARP and the AR image are continuously updated so that as the ARP is moved, the appearance of the AR image remains unchanged as long as the ARP is directed toward the same portion of the target object or area. If the line of sight of the ARP is moved, the AR image will change, but the content associated with the target object will remain static as illustrated in FIG. 6C.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

What is claimed is:

1. A method of dynamically projecting augmented reality information associated with a target object, the method comprising:
providing an augmented reality projector (ARP) comprising a digital image projector, a visual spectrum camera (VSC), and a sensor arrangement including at least one depth sensor, all aligned along an ARP line of sight;
directing the ARP line of sight toward a target surface of the target object;
capturing a visual digital image using the VSC and target surface data using the sensor arrangement;
determining, by an automated data processor, a pose of the ARP relative to the target surface;
constructing, by the automated data processor, an augmented reality image for display on the target surface, and
projecting, by the digital image projector, the augmented reality image onto the target surface.

2. A method according to claim 1 wherein the actions of directing, capturing, determining, constructing, and projecting are repeated on a continuous basis in real-time.

3. A method according to claim 1 wherein the action of constructing an augmented reality image includes:
using the captured surface information and the pose of the augmented reality projector relative to the target surface to determine a geometry and orientation of the target surface relative to the augmented reality projector,
wherein the augmented reality image is constructed using the geometry and orientation of the target surface relative to the augmented reality projector.

4. A method according to claim 1 wherein the augmented reality image is constructed so that, when projected on the target surface, content of the augmented reality image has the same appearance to a viewer regardless of the pose of the augmented reality projector relative to the target surface.

5. A method according to claim 1 wherein the action of constructing an augmented reality image includes compensation for projection foreshortening as a result of an angle between the ARP and the target surface.

6. A method according to claim 1 further comprising:
identifying the target object using the visual digital image; and
obtaining augmented reality object information for the target object,
wherein the augmented reality object information is used to construct the augmented reality image.

7. A method according to claim 6 wherein the augmented reality object information includes indicia associated with the target object.

8. A method according to claim 6 wherein the augmented reality object information includes image content location information.

9. A method according to claim 1 wherein the at least one depth sensor includes a depth sensing camera.

10. An augmented reality projector comprising:
a housing;
a digital image projector at least partially disposed within the housing and configured to receive digital image information and use the digital image information to project an image onto a target surface of an object along a projector line of sight;
a visual spectrum camera (VSC) at least partially disposed within the housing and having a VSC line of sight substantially parallel to the projector line of sight so as to capture a visual digital image of the target surface;
a sensor arrangement including at least one depth sensor oriented and aligned to capture surface information from the target surface; and
a data processor in communication with the digital image projector, the visual spectrum camera, and the depth sensor arrangement, the data processor being configured to
receive the captured visual digital image from the VSC and the captured surface information from the sensor arrangement,
construct an augmented reality image for display on the target surface, and
transmit the augmented reality image to the digital image projector for projection onto the target surface.

11. An augmented reality projector according to claim 10 wherein the data processor is further configured to:
determine a pose of the augmented reality projector relative to the object, and
use the captured surface information and the pose of the augmented reality projector relative to the object to determine a geometry and orientation of the target surface relative to the augmented reality projector,
wherein the augmented reality image is constructed using the geometry and orientation of the target surface relative to the augmented reality projector.

12. An augmented reality projector according to claim 10 wherein the data processor is configured to construct the augmented reality image so that content of the augmented reality image has the same appearance to a viewer regardless of the pose of the augmented reality projector relative to the target surface.

13. An augmented reality projector according to claim 10 wherein the at least one depth sensor includes a depth sensing camera.

14. An augmented reality projector according to claim 10 wherein the sensor arrangement comprises an inertial measurement unit.

15. An augmented reality projection system comprising:
a sensor and projection unit comprising
a housing,
a digital image projector at least partially disposed within the housing and configured to receive digital image information and use the digital image information to project an image onto a target surface of an object along a projector line of sight,
a visual spectrum camera (VSC) at least partially disposed within the housing and having a VSC line of sight substantially parallel to the projector line of sight so as to capture a visual digital image of the target surface,
a depth sensor arrangement at least partially disposed within the housing and being oriented and aligned to capture surface information from the target surface, and
an input/output arrangement in communication with the digital image projector, the VSC and the depth sensor arrangement; and
a mobile interface device comprising
a communication interface selectively connectable to the input/output arrangement of the sensor and projection unit,
a data processor in selective communication with the digital image projector, the VSC, and the depth sensor arrangement when the communication interface is connected to the input/output arrangement, the data processor being configured to
receive the captured visual digital image from the VSC and the captured surface information from the sensor arrangement,
construct an augmented reality image for display on the target surface, and
transmit the augmented reality image to the digital image projector for projection onto the target surface.

16. An augmented reality projection system according to claim 15 wherein the data processor is further configured to
determine a pose of the augmented reality projector relative to the object and
use the captured surface information and the pose of the augmented reality projector relative to the object to determine a geometry and orientation of the target surface relative to the augmented reality projector,
wherein the augmented reality image is constructed using the geometry and orientation of the target surface relative to the augmented reality projector.

17. An augmented reality projector according to claim 16 wherein the data processor is configured to construct the augmented reality image so that content of the augmented reality image has the same appearance to a viewer regardless of the pose of the augmented reality projector relative to the target surface.

18. An augmented reality projection system according to claim 15 wherein the mobile interface device is removably attachable to the housing.
